(19) United States
(12) Patent Application Publication
(10) Pub. No.: US 2013/0049644 A1
(43) Pub. Date: Feb. 28, 2013

(54) ACTUATOR FOR AN AIRFLOW DAMPER

(71) Applicant: Jeff Neumann, Evansville, IN (US)

(72) Inventor: Jeff Neumann, Evansville, IN (US)

(73) Assignee: HANSEN CORPORATION, Princeton, IN (US)

(21) Appl. No.: 13/214,778

(22) Filed: Aug. 22, 2011

(51) Int. Cl. F16K 31/04

(52) U.S. Cl. 318/15

(57) ABSTRACT

Disclosed is an air damper actuator operated by a brushless DC (BLDC) motor. An output shaft configured for connection to an air damper is driven by the BLDC motor. A controller receives position information indicative of an angular position of the output shaft and generates a control signal to control the BLDC motor for rotation by an amount based on the position information.

### BACKGROUND

The present invention relates generally to air handling equipment and in particular to actuators for controlling dampers used in air handling equipment.

Unless otherwise indicated herein, the approaches described in this section are not prior art to the claims in this application and are not admitted to be prior art by inclusion in this section.

Air handling equipment is used in office buildings, industrial facilities, and residential structures (apartment building, houses, and the like). Air handling equipment typically includes an air handler that conditions and circulates air; for example, as part of a heating, ventilating, and air-conditioning (HVAC) system. Air handlers usually connect to ductwork that distributes the conditioned air through the building and returns it to the air handler. Dampers are valves or plates which are placed within the ductwork to regulate the flow of air inside the ductwork. A damper may be used to cut off the flow of conditioned air (heated or cooled) to unused rooms, and to otherwise regulate the flow of air for room-by-room temperature and climate control.

Dampers are controlled by mechanical devices called actuators. A typical actuator includes a motor that is connected to the damper. The motor can be activated rotate in a clockwise direction and a counterclockwise direction to rotate the damper between a “damper closed” position (“angular position”) and a “damper open” position. Mechanical stops can be used to limit the position of the damper between the two positions. For example, a mechanical stop can be some physical obstruction that prevents the damper from rotating beyond the obstruction. Alternatively, a mechanical stop can be electrical contact (e.g., a rotary switch) that provides power to the motor and disconnects when the damper reaches the stop point, thus interrupting power to the motor.

For purposes of the present disclosure, a “0° angular position” will be understood to refer to the damper's position in the ductwork where the damper is positioned perpendicular to the airflow, thus providing maximum blockage of airflow across the damper. Likewise, a “90° angular position” will be understood to refer to the damper's position in the ductwork where the damper is parallel (edge-on) to the airflow, thus presenting a minimum aspect to the airflow.

A conventional damper actuator provides two damper positions, a 0° rotation (closed) position and a 90° (opened) position. However, actuators can be provisioned to provide an opened position that is other than a 90° position. For example, an actuator may be provisioned with mechanical stops to provide a 0° rotation (closed) position and a 60° (opened) position. The opened position may be greater than 90°. For example, an actuator may be provisioned with stops to provide a 0° rotation (closed) position and a 120° (opened) position.

Providing an inventory of different actuator positions incurs certain overhead. Separate parts may need to be manufactured with different stop positions. Alternatively, a part may be produced that employs an adjustable stop mechanism. However, the adjustable stop mechanism must be set (by the manufacturer, retailer, or end-user) before installation of the actuator. Each actuator position may require a different part number in order to track the inventory of parts.

Once installed, the actuators are effectively fixed in terms of their operating positions. For example, a 90° actuator will only operate a damper to the fully opened position or to the fully closed position. Likewise, a 60° actuator has two positions: fully closed (0° angular position) and open (60° angular position).

### SUMMARY

In some embodiments, an airflow damper actuator includes an output shaft driven by a brushless DC type of motor; e.g., a stepper motor. A position sensor connected to the output shaft provides a signal indicative of the angular position of the output shaft. A controller receives the signal provided by the position sensor and, based at least on the signal, generates a control signal to drive the motor. In an embodiment, the controller generates the control signal further based on a received input signal. In an embodiment, the control signal is a pulse width modulated (PWM) signal.

In some embodiments, the controller is a data processing unit. The data processing unit may receive a back electromotive force (BEMF) signal from the motor and the PWM signal is generated based on the BEMF signal.

The output shaft is configured for 360° of rotation. In embodiments, the output shaft can be set at a plurality of angular positions between a 0° angular position and a 360° angular position. In an embodiment, the actuator can drive the output shaft in either the clockwise or the counterclockwise direction from an initial position of the air damper.

The actuator may include a connector for inputting externally provided signals and for outputting internally generated signals. In an embodiment, a power supply voltage can be provided to the actuator via the connector. Input signals can be received via the connector. In an embodiment, an input signal can be superimposed on the power supply voltage. The actuator can receive, as an input signal, the output of another actuator. Conversely, the actuator can output a signal is received by another actuator.

The following detailed description and accompanying drawings provide a better understanding of the nature and advantages of the present invention.

### BRIEF DESCRIPTION OF THE DRAWINGS

FIGS. 1A and 1B illustrate an embodiment of an air damper actuator as installed in a portion of an air handling system.

FIGS. 2A-2C illustrate that an air damper can be operated to a plurality of angular positions by an actuator in accordance with the present invention.

FIG. 3 illustrates that embodiments of an actuator can operate an air damper for at least 360° of rotation.

FIG. 4 illustrates that embodiments of an actuator can operate an air damper in the clockwise and the counter clockwise direction from an initial position of the air damper.

FIGS. 5, 6, 6A show external views of an embodiment of an actuator of the present invention.

FIGS. 7A-7C show exploded views, illustrating internal components comprising an embodiment of an actuator of the present invention.

FIGS. 8A and 8B illustrate operation of position sensing in an actuator in accordance with the present invention.

FIG. 9 illustrates additional components on a printed circuit board.

FIGS. 10 and 10A are system block diagrams showing the operative relations between components of an actuator in accordance with the present invention.

### DETAILED DESCRIPTION

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

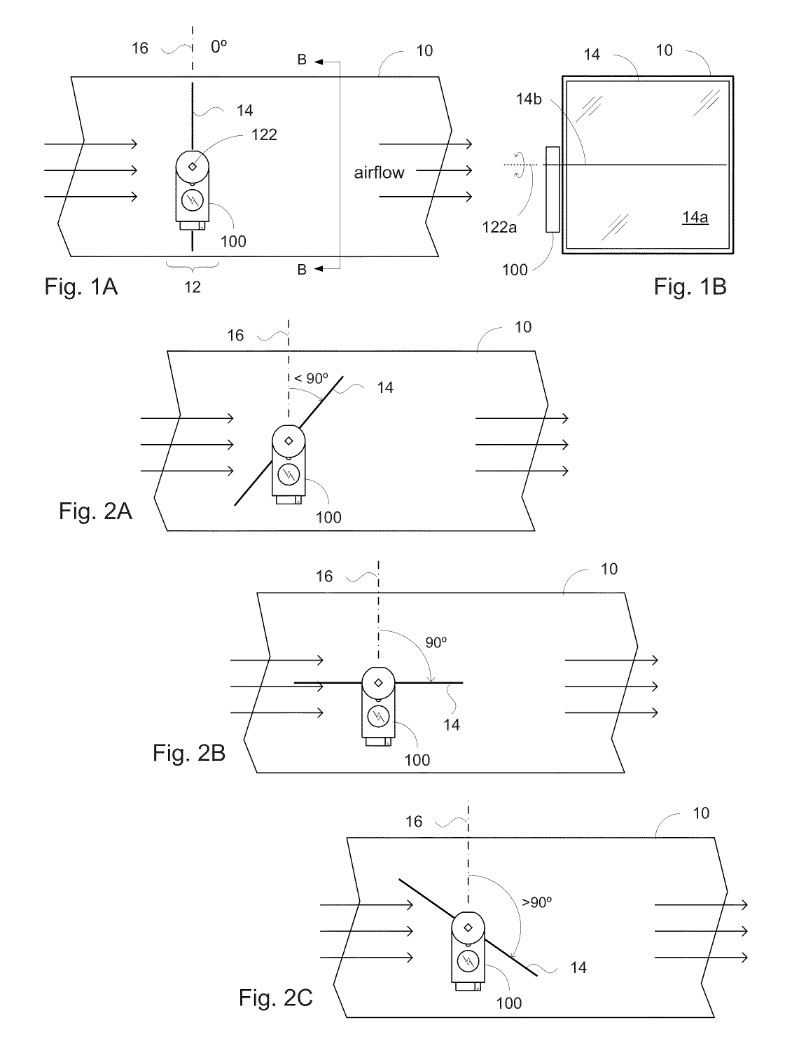

FIGS. 1A and 1B illustrate an airflow damper actuator, in accordance with an embodiment of the present invention, as deployed in an air duct such as the ductwork of an air handling system. FIG. 1A is a cutaway side view of a portion of ductwork 10 in which a damper system 12 is installed. FIG. 1B is a view looking into the ductwork in the direction indicated by view lines B-B in FIG. 1A. The damper system 12 includes a damper 14 and an actuator 100 in accordance with the present invention. The actuator 100 can be mounted to the ductwork 10 itself as represented in FIG. 1B. The damper 14 includes a vane (or plate) 14a and a connecting rod 14b attached to the vane. The actuator 100 includes an output shaft 122 for connection to the damper 14, by way of the connecting rod 14b, for rotation about an axis 122a of the output shaft. FIGS. 1A and 1B show the damper 14 in the closed position, where the damper is perpendicular to an airflow direction (arrows) within ductwork. As indicated in FIG. 1A, the angular position of the damper 14 can be measured relative to a vertical axis 16, and in the figure the closed position of the damper is a 0° angular position.

In accordance with the present invention, the damper 14 can be operated by the actuator 100 to any one of a plurality of predetermined angular positions. As will be explained below, an actuator in accordance with embodiments of the present invention can provide incremental angular positions over a full range of 360° of rotation, thus setting a damper connected to the actuator to any of a number of incremental angular positions. This aspect of the present invention is illustrated in FIGS. 2A-2C. FIG. 2A, for example, illustrates the damper 14 set to an angular position that is less than 90°. FIG. 2B illustrates the damper 14 set in a fully opened position at a 90° angular position. FIG. 2C illustrates the damper 14 being set at an angular position of greater than 90°.

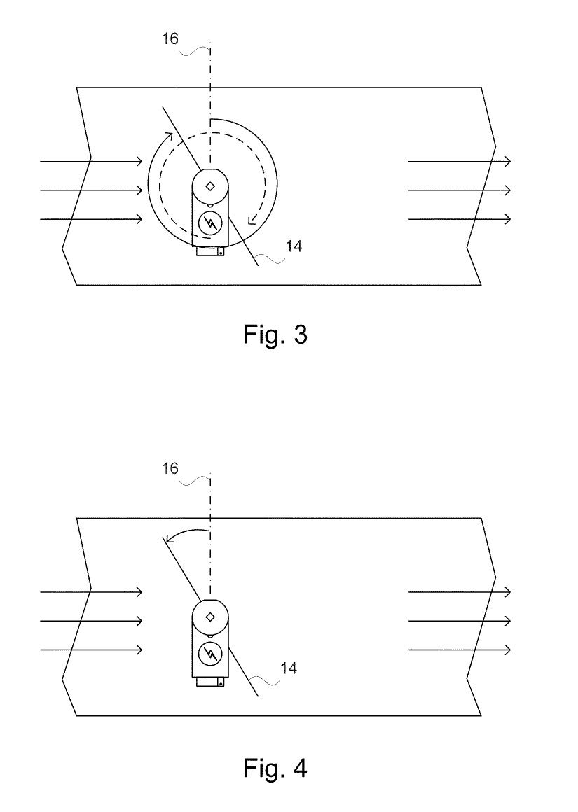

Referring to FIG. 3, in accordance with the present invention, the actuator 100 does not employ any mechanical stops to limit the amount of rotation that the actuator can provide. Accordingly, the damper 14 connected to the actuator 100 can be rotated a full 360° of rotation, as represented in FIG. 3. Since there are no mechanical stops, the damper 14 can be rotated any number of full revolutions.

Referring to FIGS. 3 and 4, in some embodiments, the actuator 100 can be operated to rotate the damper 14 in a clockwise direction (as shown in FIG. 3), or in the counter-clockwise direction (as shown in FIG. 4), relative to an initial position. For example, in an embodiment, suppose the initial position of the damper 14 is the closed position. The actuator 100 can operate the damper 14 to rotate from the closed position in either the clockwise or counterclockwise direction, as shown in FIG. 4. The actuator 100 can operate the damper 14 can be set to any of a plurality of incremental angular positions in the counter-clockwise direction, as well as in the clockwise direction.

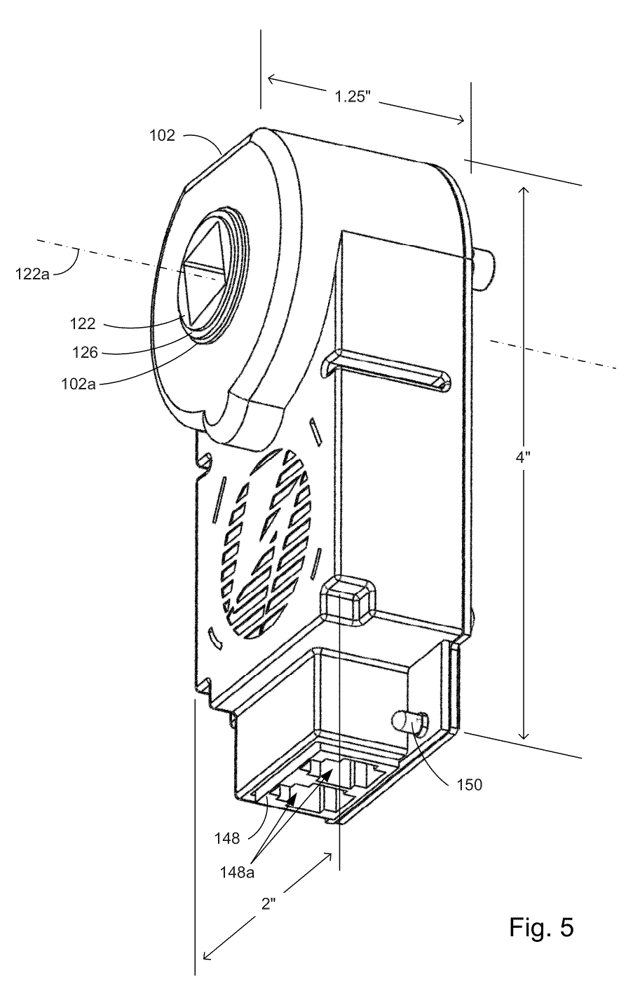

FIG. 5 is a front perspective view of a housing 102 of an actuator 100 in accordance with the present invention. Typical general dimensions for an embodiment of the actuator 100 are shown in the figure. In some embodiments, the housing 102 may be fabricated from nylon, but can be made of any suitable material.

The housing 102 includes an opening 102a to receive a bearing 126 for supporting the output shaft 122. The figure shows the axis of rotation 122a of the output shaft 122. The output shaft 122 may have a universal fitting for receiving mating adapters to adapt to customers' specific shaft requirements. For example, in an embodiment, the output shaft 122 may be provided with a ½″ square opening as the universal fitting, although other configurations may be employed.

The housing 102 may house a connector assembly 148 for receiving externally provided AC signals and/or DC levels. In an embodiment, internal signals may be read out via the connector assembly 148. A more complete description of signals will be given below. In some embodiments, the connector assembly 148 may comprise a dual ported RJ12 jack. Each RJ12 jack port 148a provides six pins for a total of twelve input pins. RJ12 jacks are standard connectors and thus the cabling and connectors for the cabling are standard and readily available. It can be appreciated, however, that any style of connector can be used.

A light emitting diode (LED) 150 can provide a visual indicator of the operational status of the actuator 100, which can be very useful during installation or when troubleshooting an installation. The LED 150 can be activated to indicate that the actuator is receiving power. The LED 150 can be a multi-colored device. For example, the LED 150 may be activated to emit red light to indicate that the actuator 100 is in the 0° position (e.g., closed position), and activated to emit green light to indicate that the actuator is in the 90° position (e.g., opened position), and so on. The LED 150 may be flashed on and off to indicate that the actuator 100 is in a diagnostic mode. Other bits of information may be indicated by varying the flash rate, or by alternating between colors, and so on.

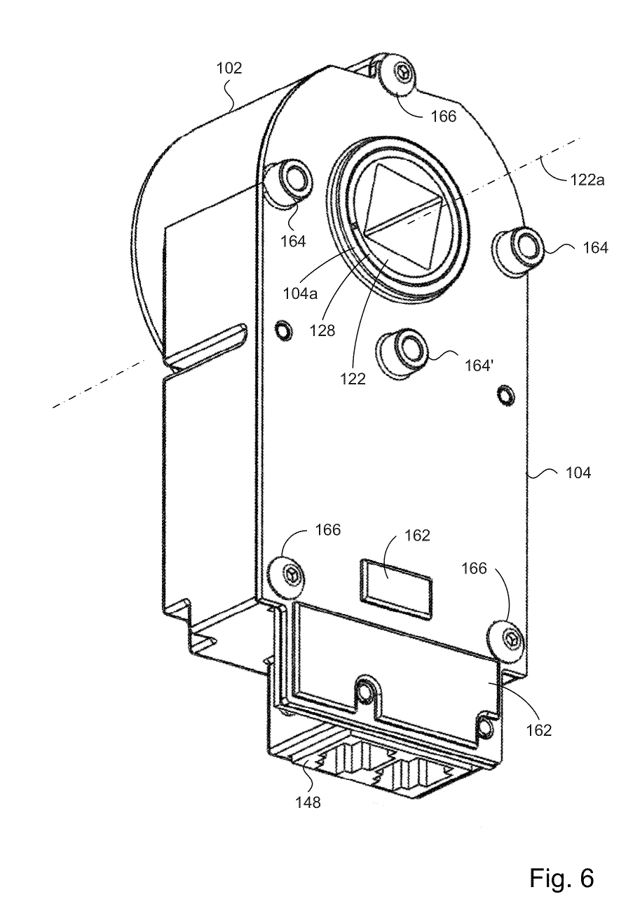

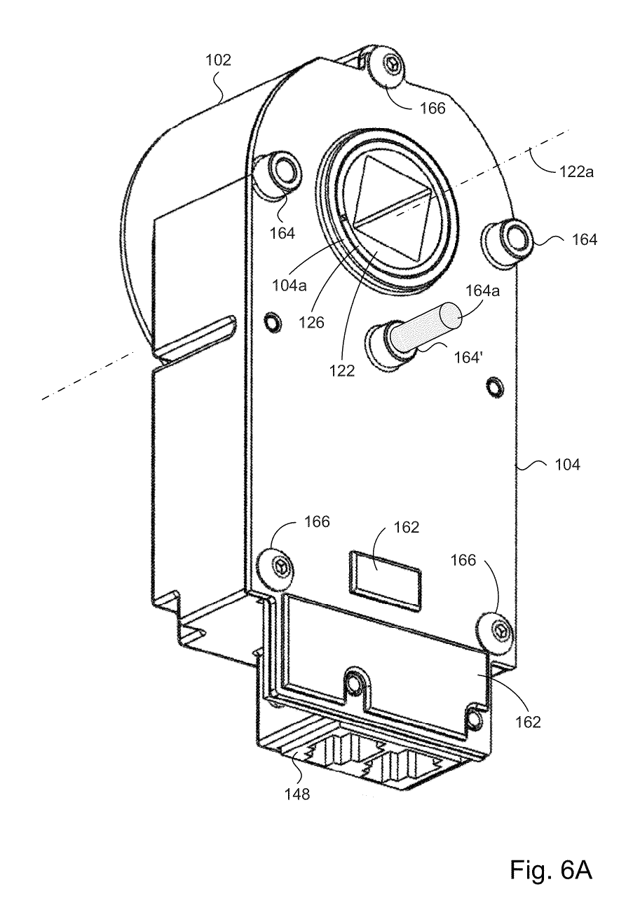

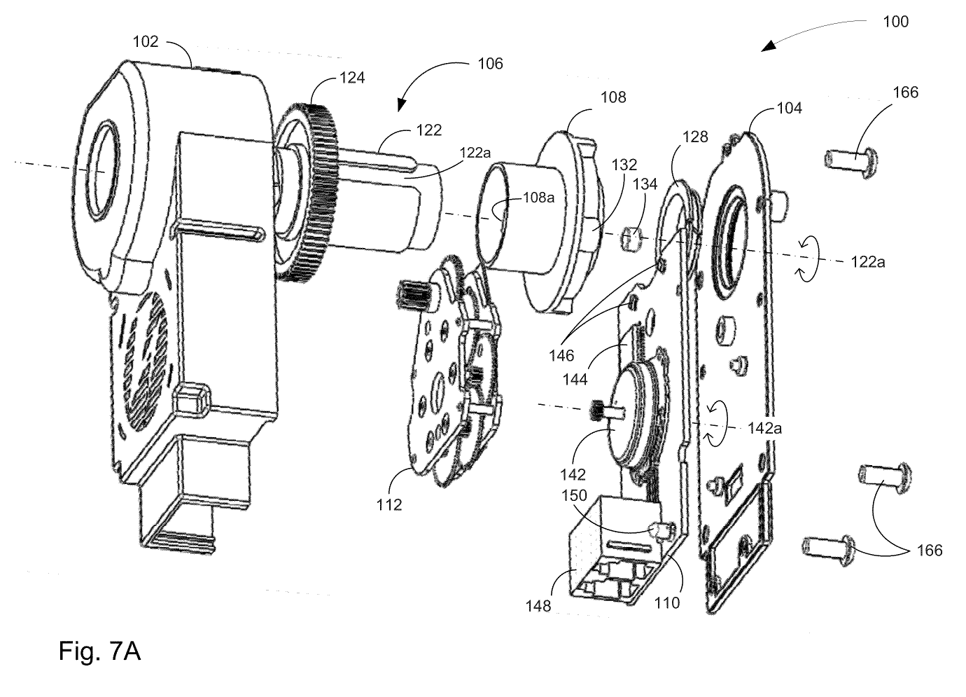

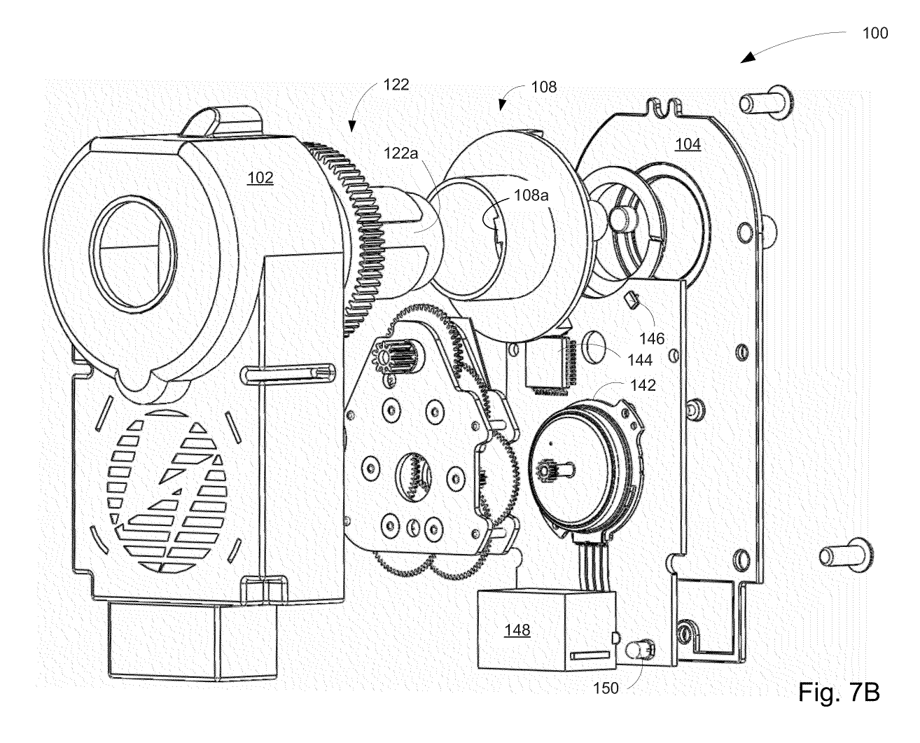

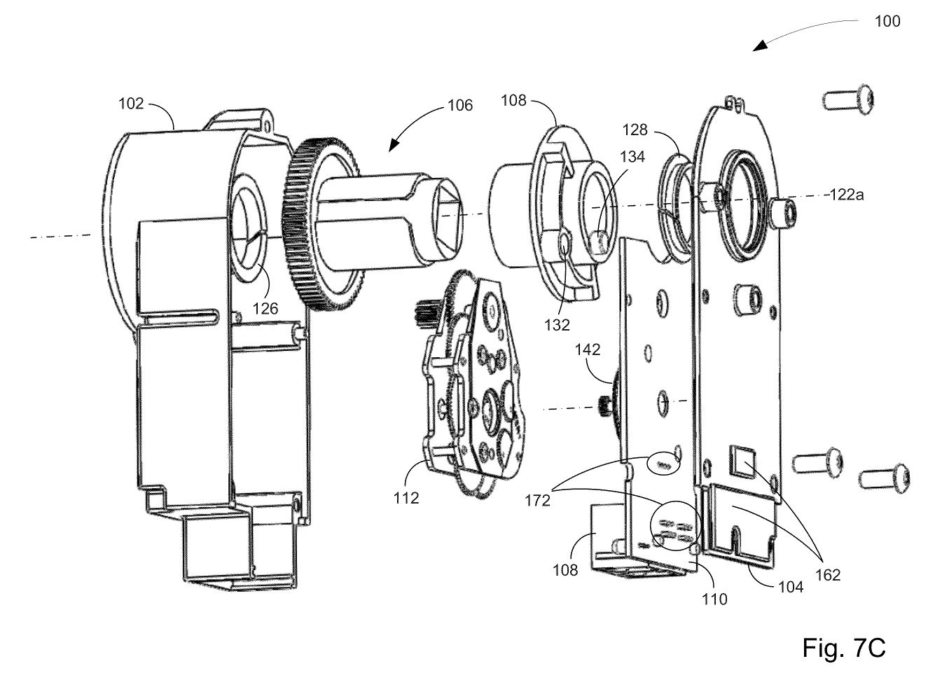

FIG. 6 is a rear perspective view of the actuator 100. A mounting base 104 serves as a base for mounting some of the internal components of the actuator 100. Assembly screws 166 may be used to secure the housing 102 to the mounting base 104. The mounting base 104 includes an opening 104a for receiving a bearing 128 to support the output shaft 122. Electrical clearance relief features 162 provide clearance for the mounting of electrical components on a printed circuit (PC) board; see, for example, FIG. 7A, where pins 172 from components mounted on a PC board 110 may require clearance.

Mounting holes 164, 164′ may be provided to mount the actuator 100 to the ductwork 10 (FIG. 1A). The mounting holes 164, 164′ may include raised portions (standoffs) to provide some amount of separation between the mounting base 104 and the ductwork 10. In some installations, it may not be possible or otherwise practical to mount the actuator 100 directly to the ductwork. In those situations, one of the mounting holes 164′ can be configured with a pin (e.g., see pin 164a in FIG. 6A) that projects out from the mounting base 104. The actuator 100 can be “mounted” by connecting the output shaft 122 to the damper. The pin 164a can then be connected to part of the ductwork assembly to prevent the actuator 100 itself from rotating during operation.

In some embodiments, the actuator 100 may comprise components shown in the exploded views of FIGS. 7A-7C. The actuator 100 includes a shaft assembly 106 comprising the output shaft 122 discussed above. The shaft assembly 106 further comprises an integral gear 124 which can be molded with the output shaft 122 to produce a unitary part. Alternatively, the gear 124 can be formed separately from the output shaft 122 and assembled to produce the shaft assembly 106. Any suitable materials can be used to manufacture the shaft assembly 106; for example, acetal is a known engineering thermoplastic used for manufacturing precision parts. The bearings 126 (FIG. 7C) and 128 (FIG. 7A) are installed into respective openings 102a and 104a of the housing 102 and the mounting base 104, respectively. The bearings 126, 128 support the output shaft 122 for rotation about the axis 122a. In an embodiment, the bearings 126, 128 are Nyliner® bearings manufactured and sold by Thomson Industries, Inc.

A position sensor ring 108 is attached to the output shaft 122 for rotation with the output shaft. The position sensor ring 108 includes a notch 108a (FIG. 7B) that slides into a groove 122a formed in the output shaft 122 when the position sensor ring is assembled to the output shaft. The notch and groove configuration ensure that the position sensor ring 108 rotates in registration with the output shaft 122. The position sensor ring 108 further includes a pocket 132 for receiving a magnet 134. Typical magnetic materials include neodymium alloys, samarium alloys, ceramics, and so on.

The actuator 100 includes a printed circuit board (PCB) 110 that can be supported by and mounted on the mounting base 104. The PCB 110 supports the connector assembly 148 and the LED 150. In accordance with the present invention, the PCB 110 includes a brushless DC (BLDC) motor 142. The motor 142 may be a stepper motor. The motor 142 can provide rotation in incremental steps (step angle) and thus can be controlled to provide a plurality of angular positions of the output shaft 122 with an angular resolution defined at least by the step angle of the motor. A gearbox 112 connects an output shaft of the motor 142 to the gear 124 of the shaft assembly 106. The gearbox 112 can be configured to provide a 1:1 gear ratio or an M:N gear ratio, where M can be greater than or less than N, depending on the requirements of the actuator 100. Thus, depending on the step angle of the motor 142 and the gear ratio of the gear box 112, the output shaft 122 can be driven in predetermined incremental angular steps to any desired angular position, where the size of the incremental steps can be viewed as the angular resolution of the positioning.

The PCB 110 further includes at least one Hall Effect Device (HED) 146. In some embodiments, the PCB 110 may include at least a second HED 146. The HEDs 146 may be aligned with respect to the path of travel of the magnet 134 as the position sensor ring 108 rotates about axis 122a.

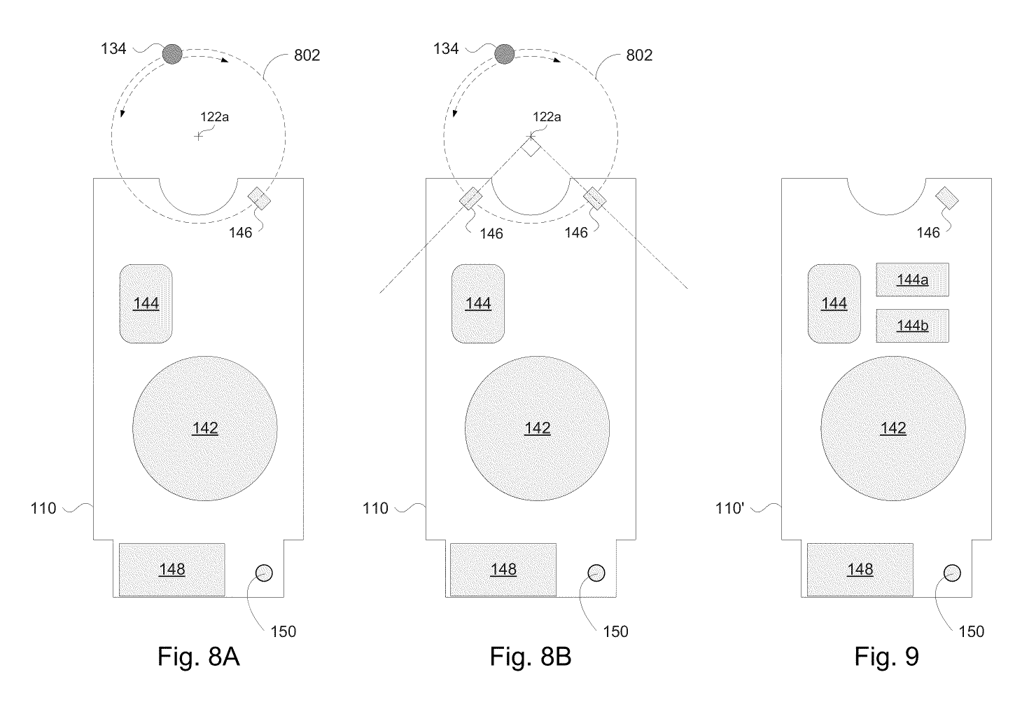

Referring to FIGS. 7A and 8A, the positioning of an HED 146 on the PCB 110 will be explained. The path of travel of the magnet 134 as the position sensor ring 108 rotates about axis 122a is projected onto the PCB 110 and is indicated by a dashed line 802 in FIG. 8A. Accordingly, the HED 146 may be placed on the PCB 110 anywhere along the line 802. A Hall voltage will develop across the HED 146 each time the magnet 134 rotates past the HED, thus providing information about the angular position of the position sensor ring 108 and hence information about the angular position of the output shaft 122.

In some embodiments, an additional HED can be mounted on the PCB 110 to provide additional angular position information. For example, FIG. 8B shows two HEDs 146 positioned on the PCB 110 and separated by 90° of angular rotation along the line 802. In this configuration, the actuator 100 can readily detect 90° of rotation simply by detecting the passage of the magnet 134 past one HED 146 and the passage of the magnet 134 past the other HED 146.

Returning to the description of FIGS. 7A and 7B, the PCB 110 may include a suitable controller 144 to operate and access the actuator 100. The controller 144 may be any suitable data processing unit. For example, the controller 144 may be a data processing unit such as a general purpose processor, a custom application specific IC (ASIC), a digital signal processor (DSP), and so on. In some embodiments, the controller 144 may include on-chip dynamic memory and static memory. In other embodiments, memory (e.g., FLASH memory) may be provided off-chip as a separate chip. FIG. 9, for example, shows an embodiment of a PCB 110′ that includes a memory chip 144a. In some embodiments, additional circuitry 144b may also be provided; for example, the additional circuitry may be a wireless communication chip.

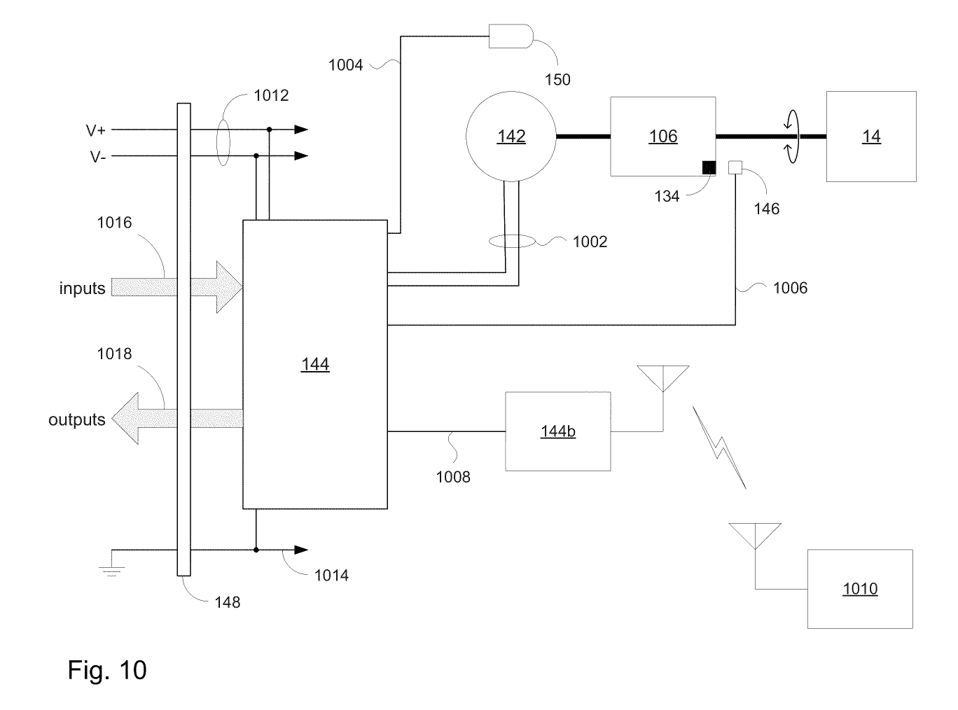

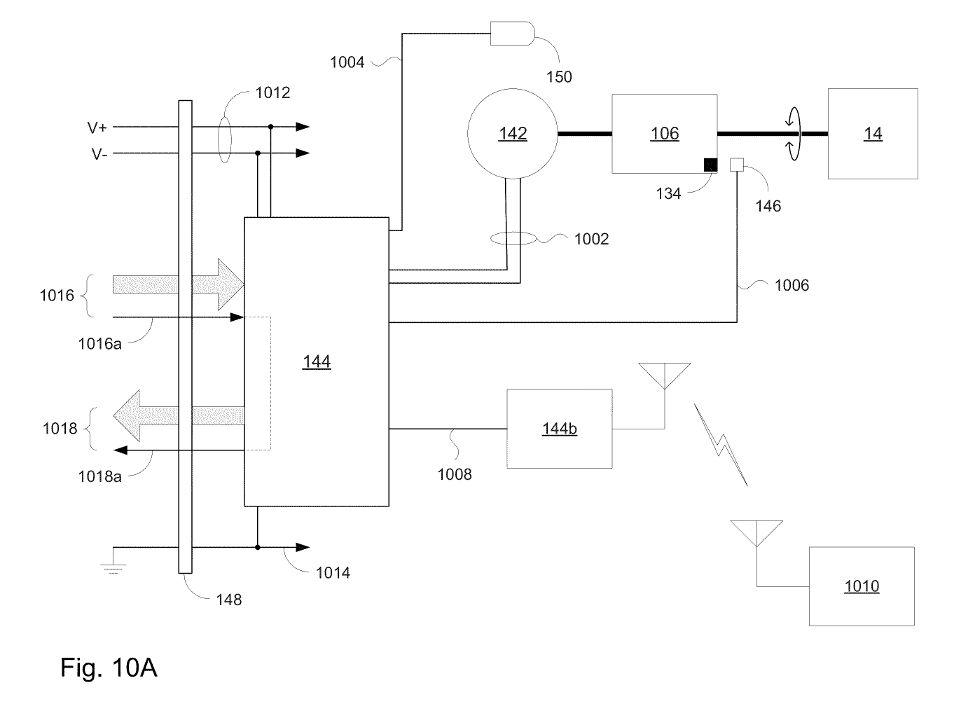

FIG. 10 represents a system diagram in accordance with embodiments of the present invention. The motor 142 is shown connected to the output assembly 106, which in turn is connected to a damper 14 (FIG. 1). The controller 144 may be any suitable processing unit that can be configured for output signals and input signals. The capability of the controller 144 (e.g., in terms of functions provided) will depend on the specific implementation and capabilities of the specific controller used. For example, more or less functionality may be provided for a given controller depending on how many I/O pins are provided. Accordingly, it will be appreciated that the following functions and capabilities discussed below may or may not be implemented in a given embodiment of the present invention, and will depend on parts counts, costs, footprint, and other considerations not relevant to the present invention.

The controller 144 may output control signals 1002 to drive the motor 142; for example, the control signals may be pulse width modulated (PWM) signals. As will be discussed below, the motor 142 may be driven in response to various user inputs and conditions provided to the controller 144.

The controller 144 may output an LED signal 1004 to drive the LED 150. As mentioned above, the LED 150 may be activated in any of a number of ways to visually indicate a state of operation of the actuator 100. Accordingly, the controller 144 may output a suitable LED signal (or signals) 1004 to activate the LED 150 to produce different effects such as color output, flash on and off, flash on and off at different rates, and so on.

The controller 144 may receive a position sensor signal 1006 indicative of changes in the angular position of the output shaft 122. For example, referring to FIGS. 7A and 8A, each time the magnet 134 located in the position sensor ring 108 passes near the HED 146 as the output shaft 122 rotates, the HED will generate a HALL voltage that can feed into the controller 144 where the HALL voltage can serve as the position sensor signal 1006. In some embodiments, additional HEDs 146 may be provided where each HED outputs a HALL voltage that feeds into the controller 144 as separate position sensor signals.

In an embodiment that includes additional circuitry 144b, the controller 144 may communicate with the additional circuitry via signal line(s) 1008. For example, if the additional circuitry 144b is a wireless communication circuit, signal line(s) 1008 between the controller 144 and the wireless communication circuit may include data lines allowing for communication with an external receiver 1010.

The connector assembly 148 provides an interface for receiving and outputting signals between the actuator 100 and the external environment. As explained above, in embodiments, the connector assembly 148 may employ dual standard RJ12 connectors which are conventionally used for telephone systems. However, the cabling can be readily adapted to provide electrical signaling other than telephone signals. For example, the pins on the RJ12 connectors can be connected to voltage supply lines, input signal lines, and output signal lines.

FIG. 10 shows that the connector assembly 148 can include power supply lines 1012 to provide power supply voltage levels V+ and V− to the actuator 100. The power supply lines 1012 can be used to power the controller 144 and other electronic components in the actuator 100. A DC to DC converter (not shown) may be provided on the PCB 110 in order to derive different voltage levels other than V+ and V−. For example, the power for the HED 146 may require a different voltage level. In another embodiment, the power supply lines 1012 may carry AC voltage, in which case the PCB 100 may include a rectifier circuit (not shown) to convert the AC voltage into a suitable DC level or DC levels.

The connector assembly 148 may include input signal lines 1016 that feed into the actuator 100, and may include output signal lines 1018 to output signals from the actuator. In embodiments, such as illustrated in FIG. 10, the signal lines 1016 and 1018 connect to I/O pins of the controller 144. It will be appreciated that in other embodiments, the signal lines 1016 and 1018 may include connections directly to other electrical components in the actuator 100.

In embodiments, the controller 144 can be configured to receive any of a number of input signals. For example, in an embodiment, one or more of the input signal lines 1016 may be configured to provide temperature information from a temperature sensor positioned in a room or zone. In another embodiment, one or more input signal lines 1016 may be configured to provide a signal from a smoke detector positioned in a room or zone. In yet another embodiment, one or more input signal lines 1016 may be configured to provide a signal from a motion detector positioned in a room or a zone. It can be appreciated that the controller 144 may be configured to receive input from other sensors or detectors using still other input signal lines 1016. In some embodiments, one or more input signal lines 1016a (FIG. 10A) may be configured to receive signals from an upstream actuator and/or a downstream actuator, allowing for the actuators to be daisy chained for various purposes. For example, the actuators can be daisy chained for synchronous operation and/or for operation with an external device such as a communication device, a central controller, a thermostat, and so on. These aspects of the present invention are discussed in more detail below.

In embodiments, the controller 144 may be programmable. A pair of the input signal lines 1016 can be used for communicating with the controller 144 using a suitable communication protocol. In embodiments where the number of signal lines provided by the connector assembly 148 is limited, the power supply lines 1012 may be used for communicating with the controller 144. For example, coded pulses may be superimposed or otherwise modulated on the power supply lines 1012. The PCB 110 may include suitable demodulation circuitry (not shown) that can detect the coded pulses and produce suitable signals that can be input to the controller 144.

In embodiments, the controller 144 may provide variety of functionalities, depending on the processing and data storage capabilities of the controller 144. The following non-exhaustive list of functions may be supported by the controller 144 in a given embodiment. The controller 144 may receive an ID setting, allowing a user to identify the actuator 100 with a suitable identification code. Time and date settings may be programmed into the controller 144 if the controller includes timekeeping capability. An operating schedule may be programmed and stored in the controller 144. The operating schedule may include angular position settings to set the damper 14 at different open positions (e.g., 30°, 45°, 60°) for different times of operation. The operating schedule may include temperature readings obtained from a temperature sensor to further refine operation of the damper 14 as a function of room temperature as well as time of day.

In embodiments, the controller 144 may be configured to provide any number of output signals. A pair of the output signal lines 1018 may be used to communicate state information of the actuator 100, for example, to a communication device, a central controller, a thermostat, and so on. The state information may include the actuator's ID, operating schedule, and other information previously programmed into the actuator 100. The state information may include current time and date, current angular position of the damper 14, and so on. The state information may further include a current reading on sensors connected to the actuator 100 such as temperature sensor, smoke detector, motion detector, and so on. In some embodiments, one or more of the output signal lines 1018a (FIG. 10A) may be dedicated for connecting to upstream and/or downstream actuators in order to daisy chain together two or more actuators.

In a given installation, the actuator 100 needs to know where an initial angular position is of the damper 14 (FIG. 1) in order to subsequently operate the damper properly. For example, the initial angular position may be the fully closed position or the fully open position. Of course, any other angular position can be defined as the initial position. Accordingly, in some embodiments, the controller 144 may provide a calibration mode where the user can define the damper's initial position; for example, by using a suitable communication device connected to the actuator. For discussion purposes, assume the desired initial position is the closed position.

In some embodiments, the controller 144, in calibration mode, will first drive the motor 142 to rotate the output shaft 122 until the controller detects (via the position sensor signal 1006) that the magnet 134 in the position sensor ring 108 is aligned with the HED 146. This establishes a known “zero point” position in the actuator 100.

The “zero point” position of the actuator 100 may or may not position the damper 14 in the desired initial position. If not, the user can instruct the controller 144 to drive the output shaft 122 from the zero point position until the damper 14 is positioned in the desire initial position (e.g., fully closed). As the output shaft 122 is driven from the zero point position, the controller 144 tracks the number of step positions from the zero point position that the motor 142 is makes. When the user signals the controller 144 that the damper is in position, the controller 144 may record how many steps (and in which direction, clockwise or counterclockwise) the motor 142 made from the zero point position. This establishes the “initial position” of the actuator 100.

From the initial position, the actuator 100 can position the damper 14 to any angular position with an angular resolution defined by the step angle defined by the motor 142 and gearbox 112. The actuator 100 can always reset itself to the initial position by first reaching the zero point position, and then driving the motor 142 an additional number of steps as recorded during calibration to reach the initial position. The actuator 100 do a reset each time the damper 14 position is changed, on a periodic basis, on demand by the user, and so on.

In some embodiments, multiple actuators may be daisy chained, where each actuator is connected to another actuator. Daisy chaining allows for synchronous operation between actuators. For example, a group of actuators in a zone can be operated together by being daisy chained. A controller (e.g., a thermostat) need only be connected to the first actuator in the group. When that first actuator is instructed to open or close, it can pass the instruction to the next actuator, which in turn can pass the instruction to the next actuator, and so on down the chain. Daisy chaining can be used to control the timing of opening or closing the dampers in a zone in order to avoid sudden changes in pressure that can result if all the dampers simultaneously opened or closed, and can damage the air moving equipment.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. An airflow damper actuator comprising:
an output shaft configured for connection to an airflow damper;
a position sensor operative with the output shaft to provide a sensor signal indicative of an angular position of the output shaft;
a motor connected to rotate the output shaft; and
a controller connected to the motor and configured to produce a controller signal responsive to the sensor signal and to a received input signal, wherein the controller signal operates the motor to vary the angular position of the output shaft.

2. The actuator of claim 1 wherein the motor is a brushless direct current (BLDC) motor having a plurality step positions which define a full rotation about an axis of rotation of the motor, wherein a step position of the motor determines the angular position of the output shaft.

3. The actuator of claim 1 wherein the controller signal is a pulse width modulated (PWM) signal.

4. The actuator of claim 3 wherein the controller comprises a data processing unit, wherein the data processing unit receives a back electromotive force (BEMF) signal from the motor, wherein the PWM signal is generated based on the BEMF signal.

5. The actuator of claim 1 wherein the output shaft is configured for at least 360° of rotation.

6. The actuator of claim 1 wherein the output shaft has a plurality of angular positions between a 0° angular position and a 360° angular position.

7. The actuator of claim 1 wherein the output shaft is configured for clockwise rotation and counterclockwise rotation.

8. The actuator of claim 1 wherein the position sensor comprises:
a magnetic element connected relative to the output shaft for rotation about an axis of rotation of the output shaft; and
a Hall Effect Device disposed along a path of travel of the magnetic element,
wherein the sensor signal is an output of the Hall effect device.

9. The actuator of claim 1 further comprising a connector configured to receive a power supply voltage.

10. The actuator of claim 9 wherein the received input signal is superimposed on the power supply voltage.

11. The actuator of claim 9 wherein the power supply voltage is an alternating current (AC) voltage.

12. The actuator of claim 1 further comprising a gearbox coupling the motor to the output shaft.

13. An airflow damper actuator comprising:
an output shaft having a feature for connection to an air damper, wherein the output shaft is configured for at least 360° of rotation;
electromotive means, connected to the output shaft, for turning the output shaft;
a position sensing means to sense an angular position of the output shaft; and
data processing means, connected to the position sensing means and the electromotive means, for generating an output signal to operate the electromotive means thereby changing the angular position of the output shaft, the data processing means including one or more inputs to receive control information, wherein the output signal is generated based on an output of the position sensing means and on the control information.

14. The actuator of claim 13 wherein the electromotive means is a BLDC motor, wherein the data processing means receives a back electromotive force (BEMF) signal from the BLDC motor, wherein the output signal is generated based on the BEMF signal.

15. The actuator of claim 14 wherein the output signal is a PWM signal.

16. The actuator of claim 13 wherein the sensor means comprises a magnet mechanically coupled to the output shaft and a Hall effect device.

17. The actuator of claim 13 wherein the output shaft is configured for clockwise rotation and counterclockwise rotation.

18. The actuator of claim 13 further comprising a connector to receive input signals from a first actuator and to provide output signals to a second actuator.

19. A method for operating an airflow damper actuator comprising:
sensing a position of an output shaft which is configured for connection to an airflow damper;
generating a control signal based on the sensed position of the output shaft; and
providing the control signal to a BLDC motor, wherein the BLDC motor is mechanically connected to the output shaft, wherein an angular position of the output shaft is varied in accordance with rotation of the BLDC motor.

20. The method of claim 19 wherein the control signal is a PWM signal.
